(19) United States
(12) Patent Application Publication
(10) Pub. No.: US 2012/0069401 A1
(43) Pub. Date: Mar. 22, 2012

(54) METHOD FOR BROWSING, RECORDING MEDIUM, ACCESS SERVER AND USER STATION FOR IMPLEMENTING SAID METHOD

(76) Inventors: Daniel Fages, Miribel (FR); Mathieu Lafon, Lyon (FR); David Dupre, Lyon (FR); Albino Pili, Fontaine Sur Saone (FR)

(21) Appl. No.: 13/322,582

(22) PCT Filed: May 6, 2010
(86) PCT No.: PCT/EP10/56213

§ 371 Date: Nov. 28, 2011

(30) Foreign Application Priority Data
May 27, 2009 (FR) 0953511

(51) Int. Cl. G06K 15/02; G06F 15/16

(52) U.S. Cl. 358/1.15; 709/203

(57) ABSTRACT

The invention relates to a method for browsing the Internet, including: if a URL belongs to a pre-recorded list of URLs of sensitive websites which the user is not authorised to access from a first execution environment, then the connection to said website is only authorised (96, 114) via the remote control of a second Web browser naming in a second execution environment on an access server, in order for said second Web browser to be used instead of the first Web browser to access the sensitive website identified by said URL; otherwise, the connection (94) to the website identified by said URL is carried out using the first Web browser.

The invention relates to a method for browsing on the Internet. The invention also concerns an access server, a user station, and an information-recording medium to implement this browsing method.

The present filing party knows a method for browsing on the Internet using:

an access server connected to the Internet and capable of the parallel execution of several instances of an Internet browser in execution environments that are independent of one another, and

a user station equipped with a software program for taking remote control over an Internet browser executed on the access server, the user station being connected for this purpose to the access server by means of an information-transmission network.

This method known to the filing party comprises the remote control, from the user station, of a first Internet browser executed in a first execution environment on the access server so that this first Internet browser can connect to an Internet site identified by its URL (Uniform Resource Locator).

The Internet is also known as the World Wide Web.

An Internet browser is an application by which a user can browse on the Internet. Typically, these Internet browsers are capable of communicating with Internet servers of the Internet by using the HTTP (HyperText Transfer Protocol) and displaying pages written in an SGML (Standard Generalised Markup Language) as well as HTML (HyperText Markup Language). To this end, the browsers are capable of interpreting the HTML. At present, Internet browsers are also capable of executing and interpreting scripts contained HTML pages or transmitted by Internet servers in order to carry out operations that cannot be encoded solely in HTML. Here below in this description, the term “executed” is used to designate both the execution and the interpretation of a script.

Internet servers are content servers capable of sending HTML pages and, if necessary, scripts to the Internet browsers which interrogate them by using especially the HTTP protocol.

A remote control software program is a software program used to drive the execution of an Internet browser remotely as if the user were in front of the screen of the machine on which the Internet browser is executed. However, by means of this software program, the user can actually be physically at a great distance from this machine. To this end, a client module is installed in the user station and a server module is installed on the access server.

An execution environment or execution context designates a state of the access server defined by the computer resources allocated solely to the execution of a specific computer program as well as a set of environment values and variables to which this program has access. The computer resources are for example the processor time, the random-access and virtual memory spaces and a data storage space on the hard disk drive. Thus, the execution environments partition the computer resources in such a way that a data program executed in one execution environment cannot act on the resources allocated to another execution environment. Thus, a program executed in one execution environment cannot communicate with another program executed in another execution environment unless this has been explicitly planned by the developers of these two programs.

When a remote control software program is used to control the first remote Internet browser, only images displayable on the screen by this first Internet browser are transmitted from the access server to the user station. Thus, no script executable by an Internet browser is transmitted to the user station. On the contrary, all the scripts executable by an Internet browser are executed solely on the application server and more specifically in the execution environment allocated to the first Internet browser.

These scripts are the main vectors of malicious attacks against an Internet browser. For example, a first type of attack consists in sending scripts, from a malicious Internet site, that are designed to steal confidential information recorded in the user station. For example, the confidential information may be passwords.

Through the above browsing method, since the execution of all the scripts is confined to the applications server, access to the user's confidential information stored in the user station is not possible. At worst, the attack enables the theft of information recorded in the access server but in any case, the confidentiality of the information recorded in the user station is ensured.

This method is therefore highly efficient for combating this first type of attack. It also makes it possible to avoid resorting to an anti-virus proxy on the information stream coming from the Internet. Finally, it also makes it possible to resolve problems of capacity which arise when the user station is a terminal with a far smaller capacity than a desktop computer, for example a cell phone or a PDA (Personal Digital Assistant). Indeed, the Internet browser is not executed at the user station.

However, there is a second type of attack. This second type of attack consists in sending a script from a malicious Internet site that sends commands to the other Internet sites to which the Internet browser is connected at the same time.

Thus, if the user is connected to this malicious site and at the same to his bank's Internet site for example, then commands not desired by the user could be sent to the bank's Internet site.

The invention seeks to propose a method of browsing on the Internet that is secured against this second type of attack.

An object of the invention therefore is a method for browsing on the Internet wherein:

if the URL belongs to a pre-recorded list of URLs of sensitive Internet sites to which connection from the first execution environment is not authorized, then connection to this Internet site is authorized only on the part of the remote control of a second Internet browser executed in a second execution environment on the access server so that this second Internet browser is used, instead of the first Internet browser, to connect to the sensitive Internet site identified by its URL, and

if not, the connection is made to the Internet site identified by this URL using the first Internet browser.

In the above method, if the URL of the Internet site that the user asks for belongs to the list of URLs of sensitive Internet sites, then access to this sensitive site from the first execution environment is blocked. Thereupon, access to this sensitive site is authorized solely on the part of the remote control of the second Internet browser executed in a different execution environment. Thus, if the user is connected to the malicious Internet site by means of the first Internet browser, then an attack of the second type cannot affect the sensitive Internet site. Indeed, in no case will the first Internet browser be able to transmit commands to the second Internet browser when they are executed in different execution environments. This means that although the user is connected simultaneously to the malicious Internet site and to the sensitive Internet site, the sensitive Internet site is protected against attacks of the second type.

In the above method, the user station is also protected against attacks of the first type.

The embodiments of this method may comprise one or more of the following characteristics:
if the URL belongs to the pre-recorded list of URLs of sensitive Internet sites, then the remote control of the first Internet browser is automatically replaced by the remote control of the second Internet browser executed in the second execution environment on the access server so that this second Internet browser, instead of the first Internet browser, connects with the Internet site identified by this URL;
the access server automatically chooses the Internet browser over which the user takes remote control from his user station depending on the Internet site that the user wishes to connect with, from among several possible Internet browsers differentiated from one another either by their configuration or their version numbers or their editors;
in response to a command for printing an HTML (HyperText Markup Language) page, the Internet browser executed on the access server records the HTML page to be printed in a printable file devoid of script executable by an Internet browser, and then the method comprises the transfer of the printable file to the user station and the printing of the printable file locally by the user station;
the method comprises the following:
   in response to a command for downloading a file from an Internet site to which the Internet browser is connected, the access server records the downloaded file in a buffer memory of the access server,
   an anti-virus software program is executed by the access server to ensure that the file recorded in the buffer memory is devoid of computer viruses or any other malware, and then
   the file recorded in the buffer memory is downloaded to the user station;
in response to a command for downloading a file from an Internet site to which the Internet browser is connected, the method comprises the following:
   the downloading, by the Internet browser executed on its access server, of the file and the recording of this file on a buffer memory connected to the access server,
   during the downloading, the reception by the access server of a command for ending the remote control of the Internet browser, and
   in response to this command, the immediate stopping of the remote control and the continuation of the execution of the Internet browser by the access server in such a way as to download the complete file and then record it in the buffer memory;
the access server authorizes and, alternately, automatically inhibits a functionality of the Internet browser depending on the Internet site with which the user wishes to connect;
the functionality that is authorized and alternately inhibited is that of the transfer of a printable file or the downloading of a file recorded in the buffer memory.

These embodiments of the method furthermore have the following advantages:

the fact of automatically replacing the remote control of the first Internet browser by that of the second Internet browser when this is required simplifies the implementation of the method since the user has no additional operation to perform as compared with the case where the same Internet browser will be used to connect to the different Internet sites;

the automatic choice by the access server of the Internet browser over which the user must take remote control enables the resolution, without the user's intervention, of the problems of compatibility between the Internet browsers and the Internet sites with which the user wishes to get connected;

the recording of the page to be printed and then its transfer to the user station enables the local printing of an HTML page on the user station while at the same time preserving a high level of protection against attacks of the first and second types;

the execution of the anti-virus software program on the access server enables the recording on the user station, in full security, of the files downloaded from an Internet site without the user station being necessarily equipped with an anti-virus software program;

the continuing of the execution of the Internet browser on the access server makes it possible to continue the downloading of a file even if the user no longer has remote control over the Internet browser;

the authorizing, and alternately, the inhibiting of the functionalities of the Internet browser depending on the Internet site to which the user wishes get connected makes it possible to restrict certain functions of the Internet browser, depending not on the Internet browser used but on the Internet browser with which the user gets connected.

An object of the invention is also an information-recording medium comprising instructions for executing the above browsing method when these instructions are executed by an electronic computer.

An object of the invention is also an access server to implement the above browsing method, this server being capable of the parallel execution of several Internet browsers in execution environments that are independent of one another so that a user station can take remote control over an Internet browser executed in a first execution environment on the access server so that this first Internet browser connects to an Internet site identified by its URL. This access server is also capable:

if the URL belongs to a pre-recorded list of URLs of sensitive Internet sites to which connection from the first execution environment is not authorized, the connection to this Internet site is authorized only on the part of the remote control of a second Internet browser executed in a second execution environment on the access server so that this second Internet browser is used instead of the first Internet browser to connect to the sensitive Internet site identified by this URL, and capable

if not, of getting connected to the Internet site identified by this URL by means of the first Internet browser.

Finally, an object of the invention is also a user station for the implementing of the above method for browsing, this user station being equipped with a software program for taking remote control of an Internet browser executed on the above access server when the user station is connected, for this purpose, to the access server by means of an information-transmission network.

The invention will be understood more clearly from the following description, given purely by way of a non-exhaustive example made with reference to the appended drawings, of which:

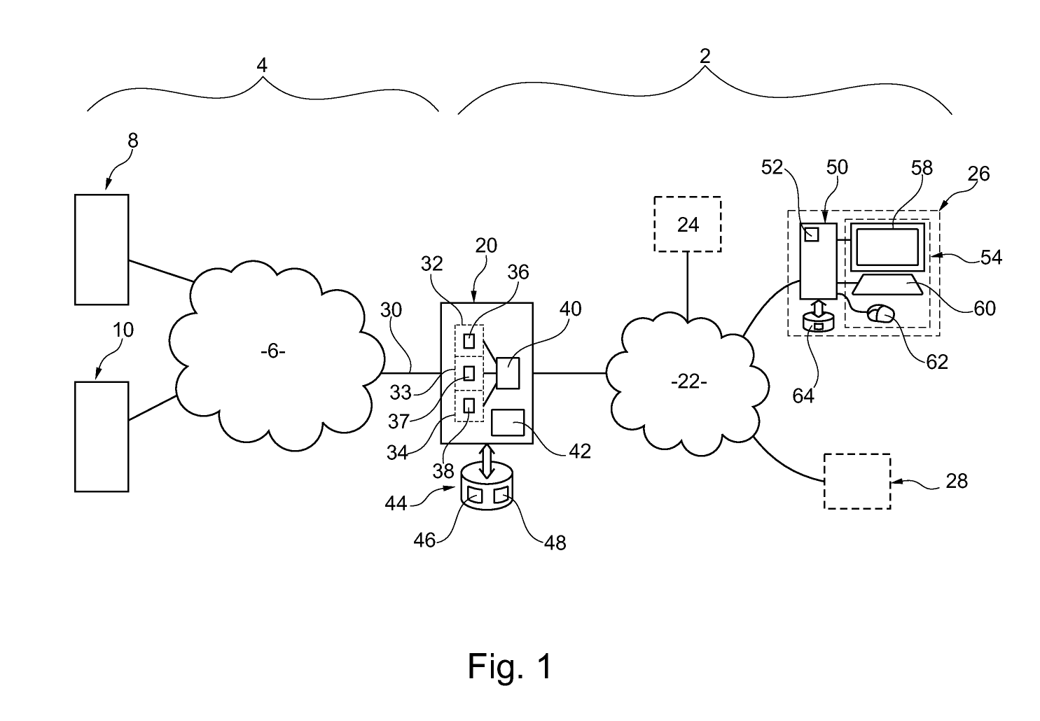

FIG. 1 is a schematic illustration of a system for browsing on the Internet;

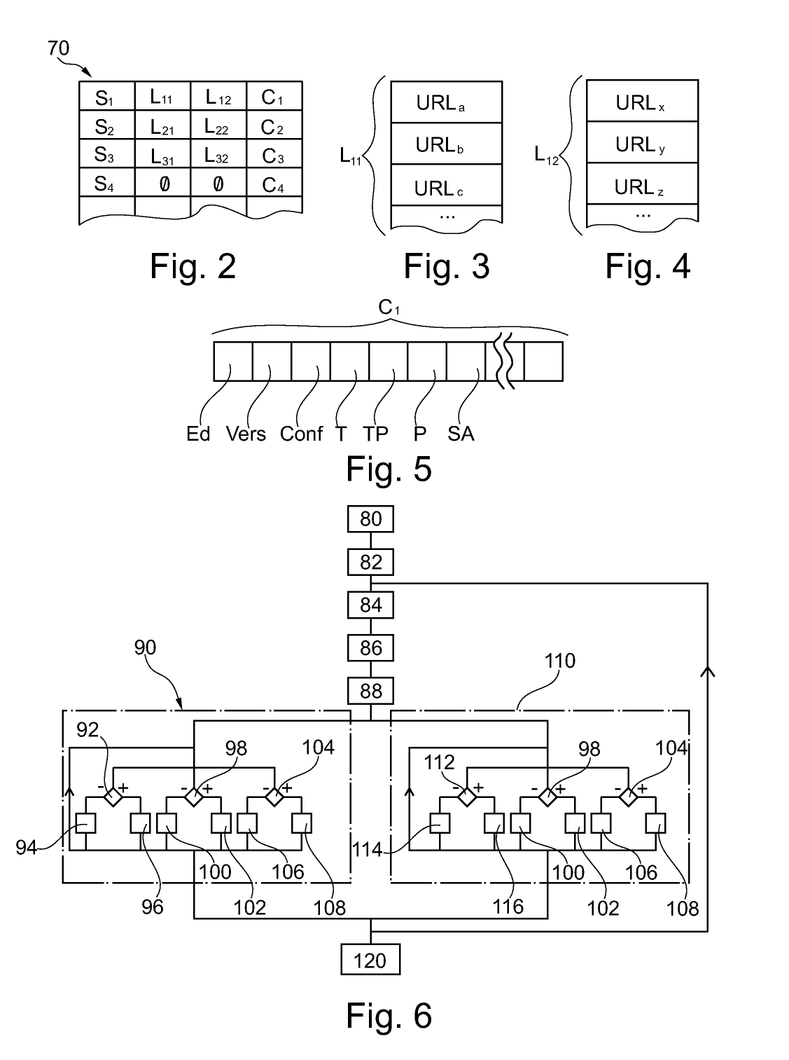

FIG. 2 is a schematic illustration of a table for the configuration of Internet sessions;

FIGS. 3 and 4 are schematic illustrations of sensitive URL lists used in the system of FIG. 1;

FIG. 5 is a schematic illustration of a list of configuration parameters of an Internet browser used in the system of FIG. 1; and

FIG. 6 is a flowchart of a method for browsing on the Internet using the system of FIG. 1.

FIG. 1 shows a system 2 for browsing on the Internet 4.

The Internet 4 is formed by numerous Internet servers connected to one another by means of a set 6 of long-distance information-transmission networks. This set 6 incorporates especially many routers so that it can route the information delivered by a server to any terminal connected to one of the networks of the set 6. By way of an illustration, only two Internet servers 8 and 10 have been shown. The server 8 is a sensitive Internet server. The term “sensitive” designates, in this embodiment, a server that must be protected against second type attacks. For example, the Internet server 8 is an Internet server that enables online handling of bank accounts.

Conversely, the server 10 is a malicious Internet server. The term “malicious” in this embodiment designates a server hosting applications designed to carry out attacks of the first or second type against Internet browsers.

The system 2 comprises:

a server 20 providing access to the Internet 4;

several user stations connected to the server 20 by means of a local area network 22; and

a station 24 for configuring the server 20 by means of the network 22.

To simplify the illustration, only two user stations 26 and 28 have been shown. For example, the stations 26 and 28 are identical and only the station 26 will be described in detail.

The server 20 is connected to the Internet 4 by means of an information-transmission link 30. It is capable of simultaneously executing several Internet browsers in distinct execution environments. For example, in FIG. 1, three distinct execution environments 32, 33 and 34 are schematically represented by rectangles of dashes. The Internet browsers executed in each of these environments 32 to 34 are represented by squares 36, 37 and 38 in unbroken lines.

The server 20 also has a server module 40 of a software program for the remote control of the Internet browsers executed by the server 20. For example, the taking of remote control over the Internet browsers executed on the server 20 is done by means of the NX protocol which is distributed in particular by the Italian firm NOMACHINE (www.nomachine.com).

The server 20 also has an anti-virus software 42. The server 20 is connected to a memory 44 containing the instructions and information needed to execute the method of FIG. 6. In particular, the memory 44 has a buffer memory 46 and files 48 for configuring different possible Internet sessions.

Each user station has an electronic computer 50 executing a client module 52 of the software program for taking remote control. For example, the computer 50 is that of a central processing unit of a desktop computer. Each user station also has a man/machine interface 54 making it possible to:

display images generated by the remote control Internet browser, and

send browser instructions to the remote controlled browser.

For example, the interface 54 is formed by a screen 58, a keyboard 60 and a mouse 62.

The computer 50 is also connected to a memory 64 comprising the instructions needed to execute the method of FIG. 6. The memory 64 also makes it possible for example to store the downloaded files.

The module 52 cooperates with the module 40 by means of the network 22 so that the user of the station 26 can control the use of the Internet browser executed on the server 20 as if this Internet browser were being executed locally by the computer 50. The remote-controlled Internet browsers are the same as those that could be directly executed on the user stations without the assistance of the modules 40 and 52.

FIG. 2 shows, in the form of a table 70, a list of Internet sessions configured on the server 20. An Internet session is a set of pieces of information used by the server 20 to configure and manage the use of an Internet browser in an execution environment dedicated to it. This table 70 is a part for example of the configuration files 48. Here, the first column of this table lists identifiers Sᵢ of different Internet sessions which the user of the station 26 can launch. The second column of the table 70 associates, with each of the identifiers Sᵢ, a pre-recorded list Lᵢ₁ of URLs of sensitive Internet sites that must be protected against attacks of the second type. The third column contains, for each session Sᵢ, a second list Lᵢ₂ of URLs of authorized Internet sites and, if necessary, accessible from other sessions. Finally, the fourth column contains, for each session Sᵢ a list Cᵢ of configuration parameters of the Internet browser. Among the four sessions S₁ to S₄ represented here, the sessions S₁ to S₃ are secure sessions because they are each associated with a non-vacant list Lᵢ₁. Only the session S₄ is an unsecured session. This unsecured session enables connection with any Internet site except the sensitive Internet sites. In particular, the session S₄ enables the user to get connected as the case may be with malicious Internet sites such as those hosted by the server 10. To this end, the lists L₄₁ and L₄₂ are non-existent and represented by the symbol φ.

FIG. 3 shows an example of a list L₁₁. In this example, the list L₁₁ has at least three URLs respectively denoted as URLₐ, URL_{b}, URL_{c}. These URLs correspond to URLs of sensitive Internet sites which have to be protected against attacks of the second type. These URLs are accessible only through the session S₁.

FIG. 4 shows an example of a list L₁₂ containing, by way of an illustration, three URLs: URLₓ, URL_{y} and URL_{z}. The URLs contained in this list L₁₂ are URLs accessible during the session S₁ but also during other Internet sessions.

FIG. 5 shows a possible example of a list C₁ of configuration parameters. For example, the list C₁ has the following fields:

a field Ed identifying the editor of the Internet browser to be used from amongst several possible Internet browsers comprising in particular Internet Explorer, Firefox, Mozilla, etc;

a field Vers containing the version number of the Internet browser to be used;

a field Conf defining the configuration of the Internet browser to be used such as, for example, additional extension modules (better known as “plug-ins”) to be executed at the same time as the Internet;

a field T containing an authorization for, or on the contrary, a prohibition against downloading files from the Internet;

a field TP containing an authorization for, or on the contrary, a prohibition against continuing to download a file after the end of the remote control;

a field P containing an authorization for, or on the contrary, a prohibition against printing files downloaded from the Internet; and

a field SA indicating whether or not the session Sᵢ associated with the list C₁ is an anonymous session.

Here, the term “anonymous session” qualifies a connection to the Internet from an Internet browser at the end of which the browsing history is erased along with any trace of Internet browsing such as cookies or the like.

The working of the system 2 shall now be described in greater detail with reference to the FIG. 6.

Initially, at a step 80, an administrator of the system 2 gets connected to the server 20 by means of the station 24 and the network 22. The administrator uses this connection to define the table 70 as well as the different lists Lᵢ₁ Lᵢ₂ and Cᵢ. After having defined the different possible Internet sessions through the server 20, the administrator records the sessions in the files 48.

Once the server 20 has been configured, it is used to browse on the Internet 4 from the station 6 in total security. In particular, at a step 82, when a user wishes to connect to the Internet 4, he launches the execution of the module 52 on his user station. The module 52 then links up to the module 40 and automatically downloads the list of Internet sessions defined in the table 70. This list is presented to the user by means of the man/machine interface 54.

At a step 84, the module 52 acquires the identifier Sᵢ of the session selected by the user of the station 26 and transmits this identifier to the module 40.

In response, at a step 86, the server 20 creates an execution environment and launches the execution in this environment of the Internet browser identified and configured as indicated in the list Cᵢ associated with the identifier Sᵢ acquired during the step 84. Thus, a sensitive site such as an Internet site enabling the management of a user's bank accounts will be accessible only by means of an Internet browser whose configuration defined in the list Cᵢ is appropriate to this use. Thus, problems of compatibility between the Internet browsers and the Internet sites consulted are avoided

Here below in this description, it is assumed that during the step 86, the server 20 has created the execution environment 32 and launched the execution of the Internet browser 36.

At a step 88, the module 52 takes remote control over the browser 36. From this instant onwards, the images displayed by the Internet browser 36 are transmitted by the module 40 to the module 52 through the network 22. The module 52 presents them to the user through the man/machine interface 54. The files transmitted from the module 40 to the module 52 encode only an image to be displayed on the interface 54. In particular, these files are devoid of script that can be executed by an Internet browser. Thus, the user station 26 is protected against any attack of the first type.

If, at the step 84, the identifier Sᵢ acquired corresponds to an unsecured Internet session such as for example the session S₄, then a stage 50 of unsecured browsing is carried out on the Internet network 4. At the stage 90, the user can browse on all the Internet sites accessible on the Internet 4, except for those corresponding to URLs listed in the lists Lᵢ₁. To this end, at a step 92, whenever the user types out a new URL or whenever he is redirected to a new URL, for example following the selection of an Internet link, this new URL is compared with the URLs contained in all the lists Lᵢ₁. If a new URL does not belong to any of the lists Lᵢ₁, then the connection to this Internet site is authorized. Thereafter, at a step 94, the Internet browser 36 connects with the Internet site corresponding to this new URL and, from this Internet site, downloads the requested HTML pages.

If not, at a step 96, the connection to the Internet site corresponding to this URL is not authorized. As a result, the connection to this Internet site is not set up. This therefore prevents the user getting connected to a sensitive Internet site during an unsecured Internet session. Thus, a simultaneous connecting with a malicious Internet site and a sensitive Internet site from an Internet browser executed in the same execution environment is automatically made impossible.

If the new URL belongs to one of the lists Lᵢ₂, then the connection to the corresponding Internet site is authorized. Then, the step 94 is performed.

At the same time, if the user commands the printing of a page downloaded by the browser 36, then, at a step 98, the server 20 checks on whether or not the field P of the list C₄ authorizes printing off from the Internet. At a step 100, if the printing is not authorized, then the printing is blocked. Conversely, if the printing is authorized, then at a step 102, the page to be printed is recorded in the buffer memory 46 in a format containing no script executable by an Internet browser. For example, the format used is the PDF (Portable Document Format). Then, at a step 102, the file recorded in the PDF format is downloaded to the user station 26 so that it can be printed locally by the station 26.

Again, at the same time, if the user controls the browser 36 to download a file, then the server 20, at a step 104, checks on whether or not the downloading of a file is authorized. To this end, it consults the value of the field T of the list C₄. If the downloading is not authorized, then at a step 106, the downloading of the file is blocked.

If, on the contrary, the downloading of files is authorized, then, at a step 108, the browser 36 downloads the file and records it in the buffer memory 46. Then, at the step 108, once the downloading is completed, the software 42 is automatically executed to ascertain that the file recorded in the memory 46 is virus-free or malware-free. The software program 42 eliminates the viruses or malware programs detected, if any.

The module 52 enables the user of the station 26 to consult the list of files downloaded and recorded in the buffer memory 46. In response to the selection by the user of one of the files of this list, the file is downloaded from the buffer memory 46 into the memory 64 of the station 26. Thus, the station 26 has no need to be equipped itself with an antivirus software program to be able to download files from the Internet in total security.

If, at the step 84, the session identifier acquired corresponds to a secured Internet session then, at the end of the step 88, a stage 110 is carried out for browsing in a secured execution environment. This stage 110 is identical to the stage 90 except that the steps 92, 94 and 96 are replaced by steps 112, 114 and 116.

At the step 112, whenever the user types out a new URL or is being directed towards a new URL, the new URL is compared with the lists Lᵢ₁ and Lᵢ₂ associated with the secured Internet session Sᵢ selected. If the new URL belongs to one of the lists or Lᵢ₂, then the connection to this Internet site from this execution environment is authorized. Thereafter, at the step 114, the Internet browser 36 gets connected to the sensitive Internet site and downloads the data to be displayed from this site.

If the new URL belongs neither to the list Lᵢ₁ nor to the list Lᵢ₂, then the connection to the corresponding Internet site is not authorized. This new URL is blocked and the Internet browser does connect to this Internet site. Thus, the invention makes it automatically impossible to access a malicious Internet site such as those hosted by the server 10 in the same execution environment as that used to access sensitive Internet sites such as those hosted by the server 8. As a result, attacks of the second type are prevented.

After the stages 90 and 110, the user can at the same time launch a new Internet session and return for this purpose to the step 84.

It can also be decided to put an end to a session. When an end-session command is received, at a step 120, the modules 40 and 52 immediately put an end to the remote control of the Internet browser executed during this session. Thereafter, the images of the Internet site are no longer displayed on the screen 58. Then, the server 20 immediately closes the connection to the Internet site consulted to this session unless a download is in progress and unless the field TP authorizes the continued downloading of the file after the end of the remote control. In the latter case, the execution of the Internet browser is continued until the entire file has been downloaded into the buffer memory 46. Thus, although the user has the impression of being disconnected from the Internet site, the downloading continues. The server 20 also checks on whether it is an anonymous session by consulting the field SA associated with this Internet session. If the answer is affirmative, the Internet server erases the browsing history as well as all the information downloaded from the Internet designed to be reused during the next connection to the same site.

Finally, after the complete file has been downloaded, or immediately if the field TP does not authorize the continuation of the downloading, the execution of the Internet browser is stopped and the execution environment in which the Internet browser was executed is destroyed. Destroying the execution environment also destroys downloaded viruses or other malware programs if any.

The method described here obliges the user to partition the secured Internet sessions from the unsecured Internet sessions. This partitioning is done by means of Internet browsers executed in different execution environments. As a result, even if the user connects simultaneously to a malicious Internet site and to a sensitive Internet site, the malicious Internet site cannot affect the working of the sensitive Internet site since the Internet browsers used to connect to these two sites are executed in execution environments that are independent of one another.

Numerous other embodiments are possible. For example, the server providing access to the Internet may consist of several machines connected to one another to give the same services as the access server 20.

The client module 52 can be recorded on a detachable recording medium connectable to the user station 26. For example, the detachable recording medium is a Universal Serial Bus (USB) stick.

As a variant, the user stations are connected to the server 20 by a long-distance network and typically by a long-distance, information-transmission public network. For example, in the latter case, the server 20 can be hosted by an Internet provider.

For the remote control, protocols other than the NX protocol can be used. For example, the RDP (Remote Desktop Protocol) by Microsoft© or ICA (Independent Computing Architecture) by Citrix© can be used instead of the NX protocol.

As a variant, rather than blocking a URL with which it is not possible to get connected through the Internet browser executed in the current execution environment, the server 20 automatically launches the execution of another Internet browser in another execution environment from which the connection to this URL is possible and the remote control of the second Internet browser automatically replaces the remote control of the first Internet browser.

When several Internet sessions are executed simultaneously, they are displayed in distinct windows on the screen 58, or, on the contrary, in one and the same window. In the latter case, the different Internet sessions executed simultaneously are displayed, for example, in different tabs of a same window.

1-11. (canceled)

12. A method for browsing on the Internet using:
an access server connected to the Internet and capable of the parallel execution of several Internet browsers in execution environments that are independent of one another, and
a user station equipped with software for remote control of an Internet browser executed on the access server, the user station being connected to the access server by an information-transmission network,
said method comprising
remotely controlling, from the user station, a first Internet browser executed in a first execution environment on the access server so that the first Internet browser can connect to an Internet site identified by a URL (Uniform Resource Locator);
if the URL belongs to a pre-recorded list of URLs of sensitive Internet sites to which connection from the first execution environment is not authorized, authorizing connection to the Internet site by remote control of a second Internet browser executed in a second execution environment on the access server, whereby the second Internet browser is used, instead of the first Internet browser, to connect to the sensitive Internet site identified by the URL, and
if the URL does not belong to the pre-recorded list of URLs, connecting to the Internet site identified by the URL using the first Internet browser.

13. The method of claim 12, further comprising, if the URL belongs to the pre-recorded list of URLs of sensitive Internet sites, automatically replacing the remote control of the first Internet browser by the remote control of the second Internet browser executed in the second execution environment on the access server so that the second Internet browser, instead of the first Internet browser, connects with the Internet site identified by the URL.

14. The method of claim 12, further comprising causing the access server to automatically choose an Internet browser over which a user takes remote control from the user station depending on the Internet site that the user has provided an instruction to connect with, from among several Internet browsers, the browsers being differentiated from one another by one of their configurations, their version numbers, and their editors.

15. The method of claim 12, wherein:
in response to a command for printing an HTML (HyperText Markup Language) page, the Internet browser executed on the access server records the HTML page to be printed in a printable file devoid of script executable by an Internet browser, and
wherein the method further comprises transferring the printable file to the user station, and printing the printable file locally by the user station.

16. The method of claim 12, further comprising:
in response to a command for downloading a file from an Internet site to which the Internet browser is connected, causing the access server to record the downloaded file in a buffer memory of the access server,
causing the access-server to execute an anti-virus software program to ensure that the file recorded in the buffer memory is devoid of computer viruses or any other malware, and
causing the file recorded in the buffer memory to be downloaded to the user station.

17. The method of claim 12, further comprising responding to a command for downloading a file from an Internet site to which the Internet browser is connected by:
causing the Internet browser executed on the access server to download the file and to record the file on a buffer memory connected to the access server,
during the downloading, receiving, by the access server, of a command for ending the remote control of the Internet browser, and
in response to the received command, immediately stopping the remote control and the continuation of the execution of the Internet browser by the access server in such a way as to download the complete file and then record the complete file in the buffer memory.

18. The method of claim 12, wherein the access server controls availability of a selected function of the Internet browser depending on the Internet site to which the browser has been instructed to connect.

19. The method of claim 18, wherein controlling availability of a selected function comprises inhibiting access to the selected function.

20. The method of claim 18, wherein controlling availability of a selected function comprises authorizing access to the selected function.

21. The method of claim 18, wherein controlling availability of a selected function comprises controlling transfer of a printable file.

22. The method of claim 18, wherein controlling availability of a selected function comprises controlling downloading of a file.

23. A computer-readable medium having recorded thereon software for controlling Internet browsing, said software including instructions that, when executed by an electronic computer, cause execution of the method recited in claim 12.

24. An apparatus for implementing a browsing method, said apparatus comprising an access server capable of executing multiple Internet browsers in parallel in execution environments that are independent of one another so that a user station can remotely control an Internet browser executed in a first execution environment on the access server and connect to an Internet site identified by a URL thereof, the access server being configured to:
if the URL belongs to a pre-recorded list of URLs of sensitive Internet sites to which connection from the first execution environment is not authorized, authorize connection to the Internet site only by remote control of a second Internet browser executed in a second execution environment on the access server, thereby causing the second Internet browser to be used instead of the first Internet browser to connect to the sensitive Internet site identified by the URL,
if the URL does not belong to the pre-recorded list of URLs, authorize connection to the Internet site identified by the URL by the first Internet browser.

25. The apparatus of claim 24, further comprising a user station connected to the access server by an information-transmission network, said user station being configured to remotely control an Internet browser executed on the access server.
